(19) United States
(12) Patent Application Publication
(10) Pub. No.: US 2017/0231304 A1
(43) Pub. Date: Aug. 17, 2017

(54) TOUCHSCREEN COMPATIBLE GLOVE SYSTEM AND METHOD OF FORMING THEREOF

(71) Applicant: Samuel David Provencher, Waltham, MA (US)

(72) Inventor: Samuel David Provencher, Waltham, MA (US)

(73) Assignee: Boston Inventions, LLC, Waltham, MA (US)

(21) Appl. No.: 15/429,357

(22) Filed: Feb. 10, 2017

Related U.S. Application Data
(60) Provisional application No. 62/294,433, filed on Feb. 12, 2016.

(51) Int. Cl. A41D 31/00; G06F 3/0354; G06F 3/044; A41D 13/08; A41D 19/00

(52) U.S. Cl. CPC A41D 31/00; A41D 13/087; A41D 19/0048; A41D 19/0024; G06F 3/044; G06F 3/03545; A41D 2300/33; G06F 2203/04107

(57) ABSTRACT

The present disclosure relates to a glove system which can shield a portion of the hand from the capacitive sensors of the touch screen, while allowing for direct touching of the screen by desired exposed portions of the hand or capacitive resistance portions of the glove. This glove system can include grip portions which have alternative materials which can selectively increase or decrease the coefficient of friction between the surface and the glove. The glove can also include finger apertures at a tip portion of the glove so as to facilitate direct touching when desired.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### PRIORITY CLAIM

This application claims the benefit of provisional patent application No. 62/294,433 which was filed on Feb. 12, 2016, which is incorporated by reference in its entirety.

### BACKGROUND OF THE INVENTION

1. Field of the Invention

The disclosure relates to gloves, and in particular gloves for use with touch screen technology or other capacitive resistance detection devices which can include capacitive resistance gloves or capacitive shielded gloves.

2. Description of the Prior Art

Present capacitive sensor screens are presently available on a wide range of every day technology items such as on tablets, smart phones, personal computers, etc. These screens typically involve the use of sensors which detect finger location by sensing a capacitance associated with human skin. As such early versions required the user to touch the screen with a physical finger, which can leave smudges from the oils of the skin. Additionally, in varying temperatures, the capacitance of a finger can change drastically and can cause problems in detection. As such, companies have begun developing gloves for use with such technology which have embedded capacitive properties. Another problem arising in the use of touch screen technology is that it is being adapted to accept various computational inputs such as writing or other inputs which eliminate the use of a standard keyboard or other known input devices, such as fingers, and allow the use of more precise instruments such as styli, which often require the resting of a portion of the palm on the screen during use. When providing this input, users often desire to rest their hand directly on the screen, which causes the screen to detect a touch that is likely an unwanted detection. This unwanted touching of the screen can also be solved through the use of a non-capacitive glove, but which then typically requires the use of a capacitive stylus. Such gloves can often be problematic as they slide unnaturally on the screen's glass surface, which can result in an unnatural feel when writing with the stylus and can cause problems when finger touching is desired.

### SUMMARY OF THE INVENTION

The present invention seeks to overcome many deficiencies present in the prior art by providing a glove system which can shield a portion of the hand from the capacitive sensors of the touch screen, while allowing for direct touching of the screen by desired exposed portions of the hand or capacitive resistance portions of the glove. Additionally, some unpowered styli will not work if some part of the skin is not touching it as they rely on capacitance gained through touch so as to interact with the touch screen. For this reason, the stylus itself may not be able to be detected if it were shielded by a glove that completely disconnects the hand from the stylus.

In order to address these deficiencies, the glove system as contemplated herein can include a touchscreen compatible glove, the glove can include one or more finger covers configured to cover an edge portion of a fifth finger of a user's hand, or in other words the portion of the hand typically rested against a surface on which a user is writing. As such it will be appreciated that the one or more finger covers can be formed of a capacitive shielding material.

The glove can also include a hand cover portion configured to cover an anterior portion of a user's palm adjacent the fifth finger as well as a rear portion located proximal the back of the user's hand. A closure strap can then be provided which can be connected to the hand cover portion and configured to attach around a wrist portion of the user's hand to the anterior portion.

In some embodiments one or more finger anchors can be provided about a distal portion of the one or more finger covers. In yet additional embodiments one or more palm anchors can be provided about a screen contacting portion of the hand cover portion. In some such embodiments, the one or more finger anchors can include a patterned contact surface area. In yet additional embodiments, these finger anchors can be configured such that features of the patterned contact surface area decrease in relative density in a radial outward direction. Some such embodiments include situations in which the features of the patterned contact surface area decrease in relative density in a linear ratio with respect to an associated radius. In other similar embodiments, the features of the patterned contact surface area are provided with an increased relative density about a first edge, and a decreased relative density about an opposing edge.

In some alternative embodiments, the one or more finger anchors can be provided or formed as a multi-pointed star pattern. In yet additional embodiments, the patterned contact surface area can be provided with at least one tapering triangular portion.

In yet additional embodiments the glove system can further include a dexterous portion configured to cover at least a portion of the thumb and index finger of the user's hand. In some such embodiments, the dexterous portion can be formed of a capacitively-reactive material differing in material from the capacitively shielded portion. However, in some embodiments the dexterous portion can also be formed of a capacitive shielding material.

In yet additional embodiments one or more apertures can be formed in a tip portion of one or more of the finger portions.

In yet additional embodiments one or more stylus anchors can be provided on an interior portion of one or more of the finger covers, the stylus anchors being configured to aid with a grasping action of a stylus held by the user's hand.

It will also be appreciated that in some embodiments the closure strap can be configured to close about a back portion of the user's wrist so as to ensure that any increased mass of the clasping mechanism does not interfere with screen interaction or cause discomfort for the user. However, the clasp can also be configured to close about a front portion of the user's wrist in a strategic location that will not cause discomfort or interference for the user.

In some embodiments, the closure strap can be provided with a magnet embedded therein, the magnet being configured to attach to a magnetically reactive substance embedded in the hand portion. Alternatively, the hand portion can instead be provided with a magnet embedded therein, the magnet being configured to attach to a magnetically reactive substance embedded in the closure strap.

In some embodiments, the rear portion can be provided with one or more attachment apertures along an edge thereof for connecting ancillary items such as decorations or charms. In some such embodiments, the one or more attachment apertures can be provided with a reinforcement means for preventing tearing thereof.

In yet additional embodiments, the one or more palm anchors can be provided with a patterned contact surface area. In some such embodiments, the features of the patterned contact surface area can be arranged having a varying density manner, such as dots arranged in a particular pattern wherein the dots have varying texture and size within the pattern.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-B illustrate rear (right hand version) and front (left hand version) views of a glove system having a sling portion covering the fourth and fifth fingers in accordance with various aspects of the present invention;

FIGS. 2A-B illustrate front and rear views of a glove system having a sling portion covering the fourth and fifth fingers with an alternative strap arrangement in accordance with various aspects of the present invention;

FIGS. 3A-B illustrate front and rear views of a glove system having a sling portion covering the fourth and fifth fingers as well as a dexterous portion covering the remaining fingers in accordance with various aspects of the present invention;

FIGS. 4A-B illustrate front and rear views of a glove system having a sling portion covering the fourth and fifth fingers as well as a dexterous portion covering the remaining fingers with an alternative strap arrangement in accordance with various aspects of the present invention;

FIGS. 5A-D illustrate various contact surface area arrangements illustrative of varying degrees of drag achievable using the glove systems of the present invention;

FIGS. 6A-C illustrate an alternative contact surface area arrangement and the effect of relative placement of an anchor of a particular shape and the relative effect on drag or tactile feel of the glove system in accordance with various aspects of the present invention;

FIGS. 7A-C illustrate yet another alternative contact surface area arrangement and the effect of relative placement of an anchor of a particular shape and the relative effect on drag or tactile feel of the glove system in accordance with various aspects of the present invention;

FIGS. 8A-C illustrate yet another alternative contact surface area arrangement and the effect of relative placement of an anchor of a particular shape and the relative effect on drag or tactile feel of the glove system in accordance with various aspects of the present invention;

FIGS. 9A-B illustrate yet another alternative contact surface area arrangement and a varying density pattern or solid pattern for use with a glove system in accordance with various aspects of the present invention;

FIGS. 10A-B illustrate yet another alternative contact surface area arrangement and a varying density pattern or solid pattern for use with a glove system in accordance with various aspects of the present invention;

FIGS. 11A-D illustrate end views of one or more apertures which can be provided about a distal end of the one or more finger portions and which can be utilized in any of the gloves contemplated herein;

FIGS. 12A-B illustrate front views of various steps of forming an end of a strap portion applicable for use in any of the glove systems in accordance with various aspects of the present invention;

FIGS. 13A-B illustrate perspective and side cross sectional views of a strap portion having a magnet embedded therein the strap portion being applicable for use in any of the glove systems in accordance with various aspects of the present invention;

FIGS. 14A-C illustrate various steps of a method of forming an aperture in a portion of fabric for providing any of the apertures shown in the various glove systems herein;

FIGS. 15A-B illustrate front views of partial and full hand cover glove systems having strategically placed apertures in portions of the finger portions of the glove system in accordance with various aspects of the invention;

FIG. 16 illustrates a back view of a glove system having strategically placed apertures in portions of a hand cover portion of the glove system in accordance with various aspects of the invention;

FIG. 17 illustrates a back view of a glove system having strategically placed apertures in portions of various finger portions for use with the glove systems contemplated herein in accordance with various aspects of the invention;

FIG. 18 illustrates a front view of a full hand covered glove system having strategically placed stylus grip portions on various finger portions for use with the glove systems contemplated herein in accordance with various aspects of the invention; and

FIGS. 19A-B illustrate back views of two alternative exemplary glove systems adaptable for use with any of the above discussed features which only covers the fifth finger with a capacitive shielding material.

### DETAILED DESCRIPTION

To provide an overall understanding of the systems, devices, and methods described herein, certain illustrative embodiments will be described. Although the embodiments and features described herein are frequently described for use in clothing applications, it will be understood that all the components, mechanisms, systems, methods, and other features outlined below can be combined with one another in any suitable manner and can be adapted and applied to other similar systems and in any number of suitable settings.

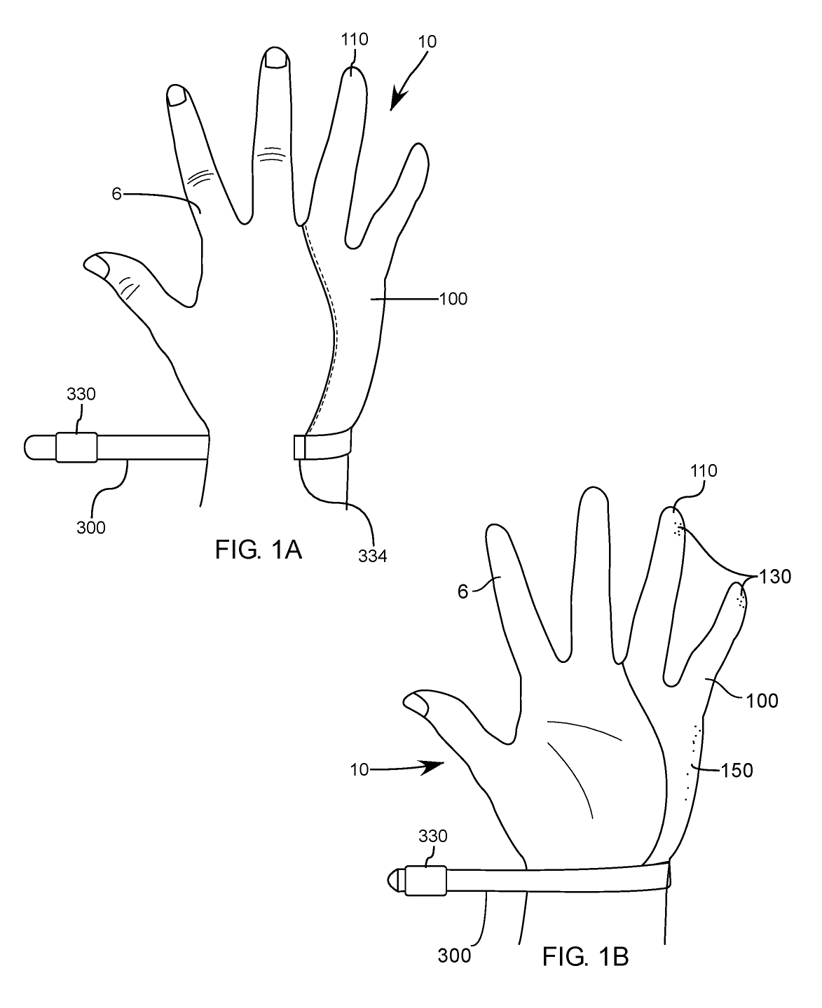

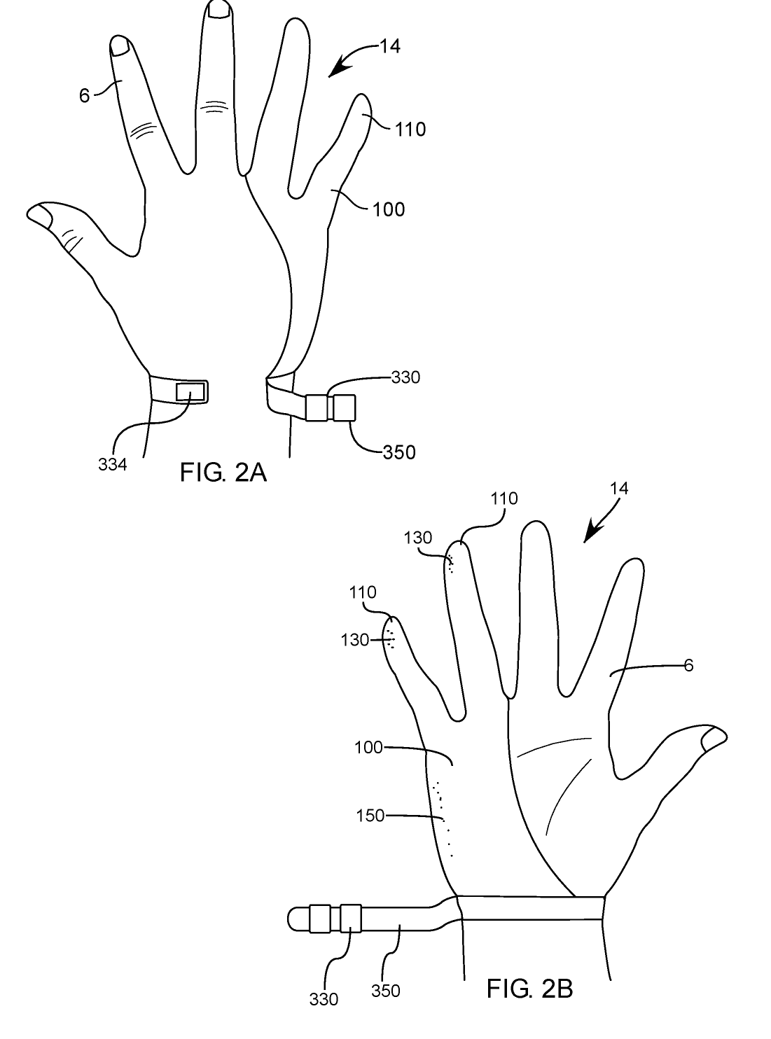

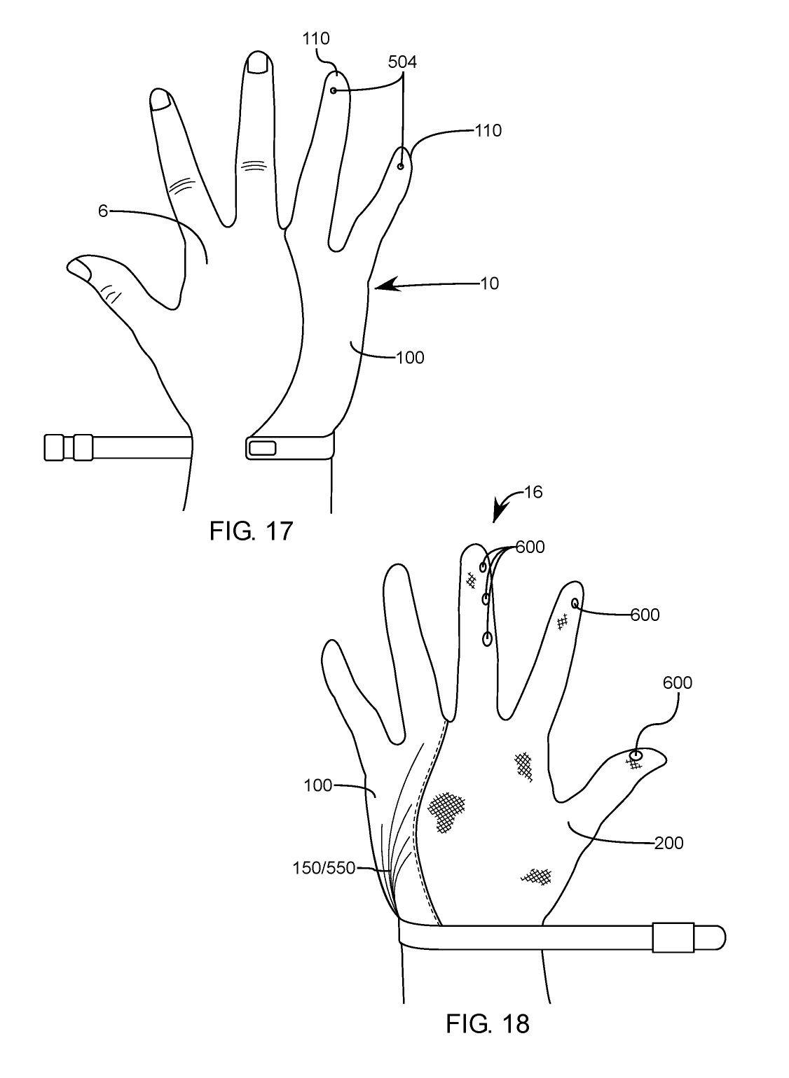

As discussed briefly above the present invention seeks to overcome many deficiencies present in the prior art by providing a glove system, many aspects of which are illustrated in FIGS. 1-19B. In particular regard to FIGS. 1-2, one embodiment of a glove system 10 is illustrated which includes a sling style hand cover portion 100 which is configured to shield a portion of the hand 6 from capacitive sensors which are commonly found in typical touch screens, such as tablets or smart phones, while allowing for direct touching of the screen by desired exposed portions of the hand 6 as illustrated. In this embodiment, the thumb, i.e. first finger, index finger, i.e. second finger, and middle, or third finger can be left exposed so as to enable a user to directly touch a touch screen of a desired device.

It will be appreciated that FIG. 1A illustrates the glove system 10 from a back side of a right hand 6, and FIG. 1B illustrates the glove system 10 from a palm or front side of a left hand 6. FIGS. 1A-B also illustrate a strap assembly 300 being configured to close the glove system by wrapping around a thumb side of the wrist.

It will be appreciated that FIG. 2A illustrates a similar open or sling glove system 14 from a back side of the hand 6, and FIG. 2B illustrates the similar open or sling glove system 14 from a palm or front side of the hand 6. However, FIGS. 2A-B also illustrate a strap assembly 350 being configured to close the glove system by wrapping around an anterior or bottom side of the wrist about the fifth finger side of the wrist.

It will be appreciated that in both embodiments of the strap assemblies 300 and 350 that they are both configured to clasp on the back side of the hand 6 such that the clasp does not interfere with the user's interaction with the touch screen, particularly when holding a stylus and resting the anterior or bottom portion of the hand on the screen while writing.

It will then be appreciated that resting the hand on a touch screen can cause difficulties for the user if the screen interprets the portion of the hand resting on the screen as a touch. As such the glove systems as contemplated herein can include a touchscreen compatible glove, the glove can include one or more finger covers 110 configured to cover at least an edge portion of a pinky finger or fifth finger of a user's hand, and in the embodiments shown herein also cover the ring or fourth finger of each hand, as both of these fingers often contact a given surface when writing with a utensil thereon, i.e. a stylus.

In order to eliminate the unwanted touch of the hand in this scenario, the hand cover portion 100 as well as the finger covers 110 can be formed of a capacitive shielding material, as most touch screens presently available rely on inherent capacitive resistance of human skin in order to detect touches. However, user's do not typically use these portions of their hands to intentionally interact with a touch screen. As such, the shielding of these portions of the user's hand can then allow for effective use of the index and middle fingers while eliminating the unwanted touches of the palm, anterior side of the hand, as well as of the ring and pinky fingers.

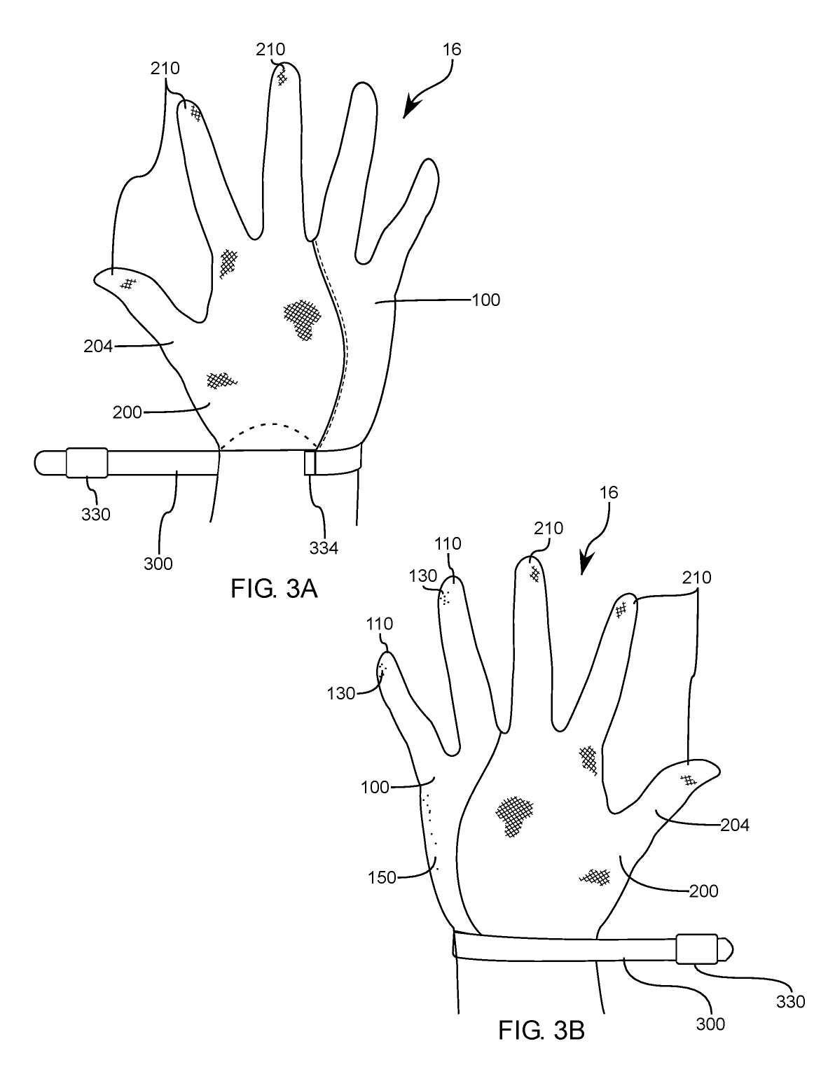

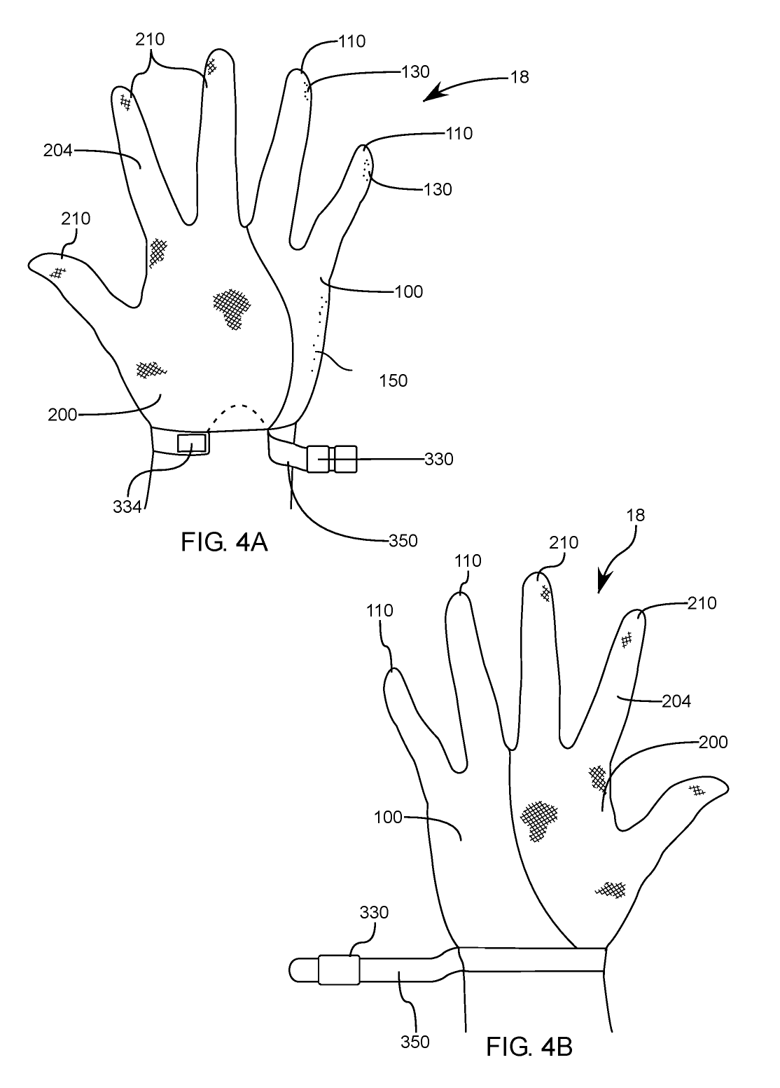

In yet additional embodiments, the glove systems 16 and 18 as shown in FIGS. 3-4, which are similar with respect to the hand cover portions of FIGS. 1-2, but are provided with a dexterous portion 200 being capable of being formed of an alternative material 204 to cover the remaining fingers with finger covers 210. In some instances, this alternative material 204 can be provided as a capacitively reactive material so as to allow direct interaction with the touch screen using the other fingers. Alternatively, this additional covering can be provided as a similar capacitive shielding material but configured to give the glove system the feel of a complete glove in accordance with user preferences.

It will be appreciated that in the various embodiments of FIGS. 3-4, that the portion of the glove systems 16 and 18 having additional covers covering the thumb, index, and middle fingers can be described as such as a dexterous portion. In some such embodiments, the dexterous portion can be formed of a capacitively reactive material differing in material from the capacitively shielded portion.

It will be appreciated that the glove system 16 of FIGS. 3A-B have a similar strap assembly to that of FIGS. 1A-B, whereas the glove system 18 of FIGS. 4A-B have a similar strap assembly to that of FIGS. 2A-B.

In some embodiments, and as shown in FIGS. 1-5, one or more finger anchors 130 can be provided about a distal portion of the one or more finger covers 110 or 210. In yet additional embodiments one or more palm anchors 150 can be provided about a screen contacting portion of the hand cover portion 100. These finger or palm anchors can provide a tactile feedback, or a more natural feel, between the user's hand and the touch screen with which the user is interacting. It has been recognized that fabrics tend to slide more easily than a hand over a screen, and as such can cause such interaction to feel alien or strange to the user wearing gloves formed solely from a capacitive shielding material. The anchors can then be implemented in a manner which can rectify the strange or foreign feel of the interaction between the glove system and the particular touch screen.

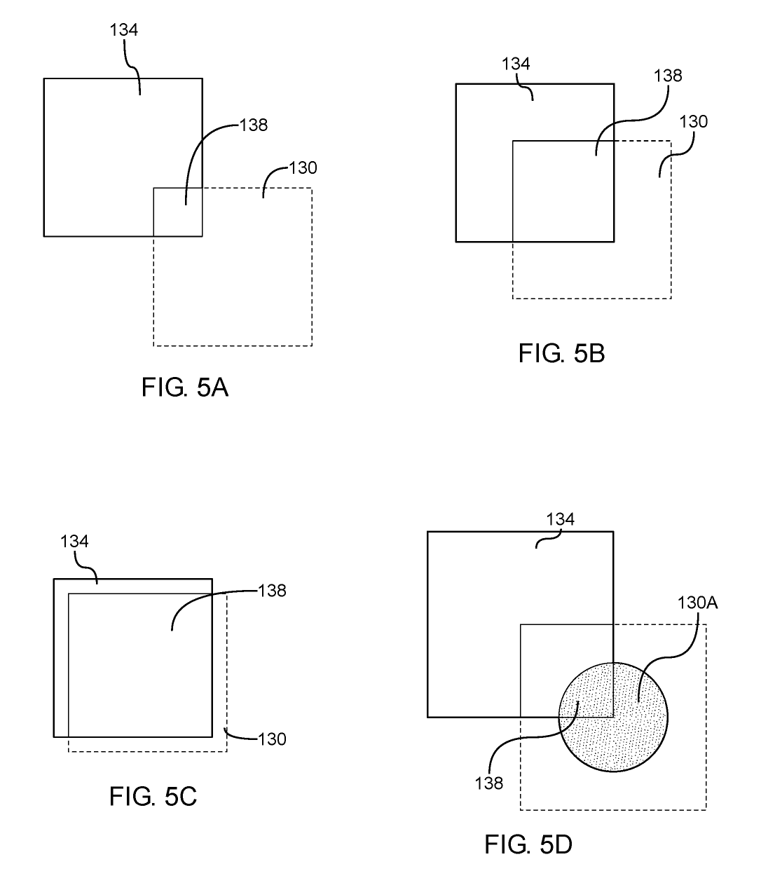

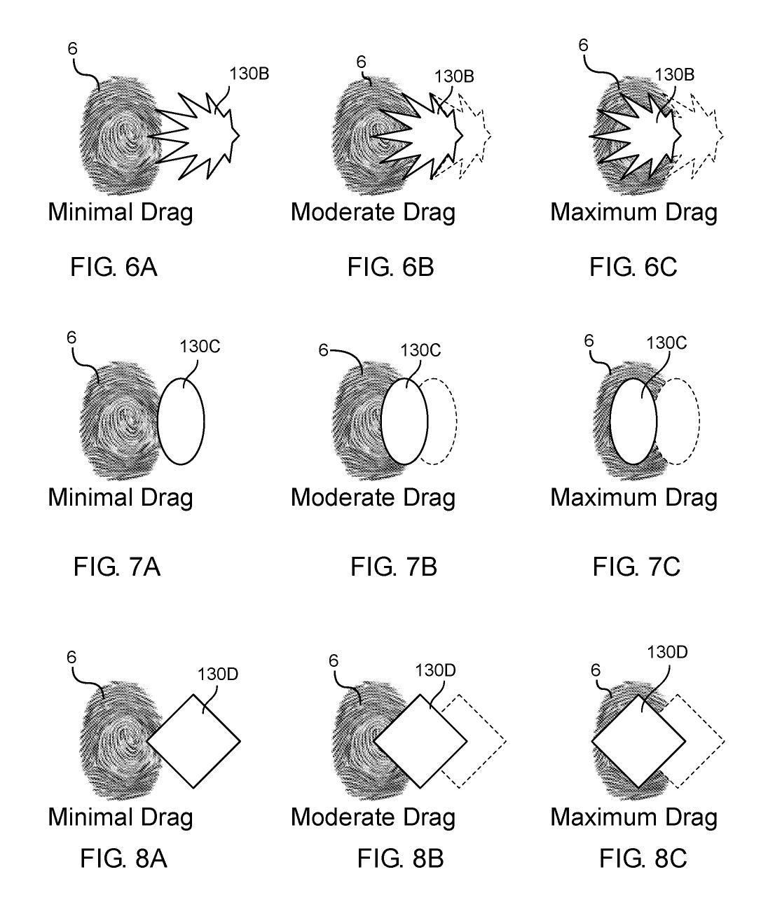

The finger or palm anchors operate on the general principle that drag can be affected by increasing or decreasing the surface area of contact between one surface and another. It will then be appreciated that the finger or palm anchors as contemplated herein can be formed of a tacky substance, such as silica gels, or other readily apparent materials as will be recognized by those having skill in the art. As such, the drag can be increased or decreased according to user preferences by increasing the surface area of contact between these anchors and the touch screen. FIGS. 5A-D illustrate how increasing or decreasing the contact area 138 between a finger anchor 130 and the touch screen 134 can increase or decrease the relative amount of drag therebetween. In particular FIGS. 5-8 illustrate, the principle that if a given anchor is wrapped around a curvature of a glove or finger that the amount of contact area between a given anchor and the screen can be increased or decreased by rotating the hand or finger to which the anchor is attached. Further, as shown by FIGS. 5D-10B the rate of increase between the contact area 138 can be altered by providing anchors of varying geometric shape. For example, a circular anchor, as illustrated by 130A in FIG. 5D, can increase dramatically as the anchor is rotated into contact with the touch screen but less dramatically toward the center of the anchor, and taper off toward the back end more dramatically. Alternative shapes are also contemplated herein, such as those shown by 130B, 130C, 130D in FIGS. 6A-8C, wherein the anchors can adjust to an increased contact area at varying rates with respect to placement of the anchor with respect to the underlying finger, as well as the rotation of the finger or anchor with respect to the touch screen. It will then be appreciated that any infinite number of shapes can be utilized so as to provide an anchor in any radial placement so as to achieve a particular drag and feel depending on a given axial placement and pressure applied.

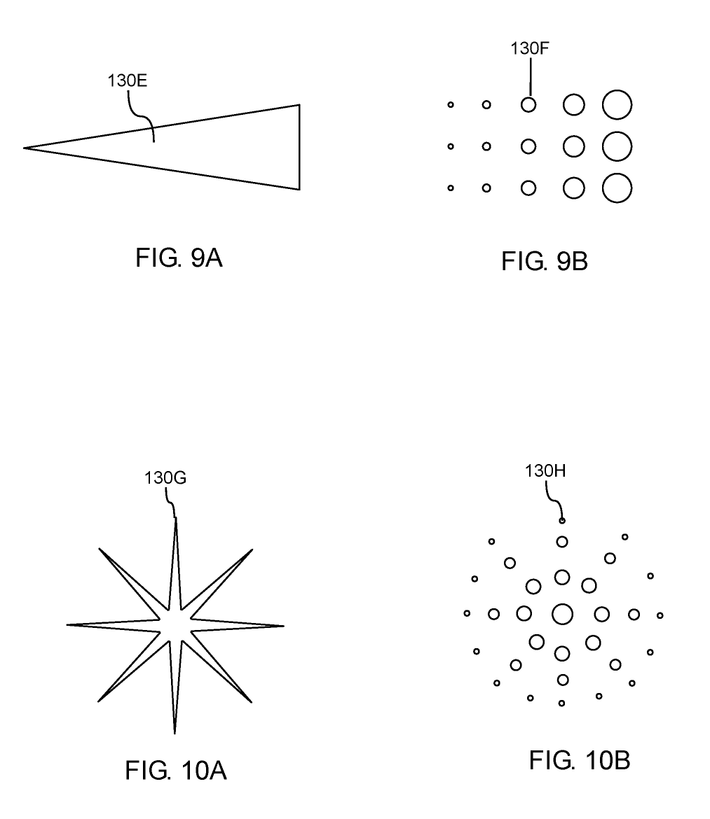

As of yet, these anchors have been shown primarily as solid shapes, however, in some such embodiments the one or more finger anchors 130 can include a solid or a patterned contact surface area as illustrated in FIGS. 9A-10B. As shown in these illustrations, it will be appreciated that any of the disclosed solid patterns can instead, be provided as a series of dots, or other geometric shapes of varying sizes as appropriate, as illustrated between anchor 130E and 130F or between 130G and 130H. Further, the dots can be of similar size or of varying size as shown so as to provide a particular drag profile with respect to angular placement of each anchor.

It will then be appreciated that in some of these embodiments the anchors illustrated are configured such that features of the patterned contact surface areas decrease in relative density in a radial outward direction. Some such embodiments include situations in which the features of the patterned contact surface area decrease in relative density in a linear ratio with respect to an associated radius such as in 130H. In other similar embodiments, the features of the patterned contact surface area are provided with an increased relative density about a first edge, and a decreased relative density about an opposing edge such as in 130F.

In some alternative embodiments, the one or more finger anchors can be provided or formed as a multi-pointed star pattern as shown in 130G-H. In yet additional embodiments, the patterned contact surface area can be provided with at least one tapering triangular portion as shown in 130E, however even the various points of the star pattern 130G can be described as tapering triangular portions.

Alternative shapes are also contemplated which are less linear, but instead implement a Fibonacci ratio or gradation which increases the density accordingly in non-linear fashions.

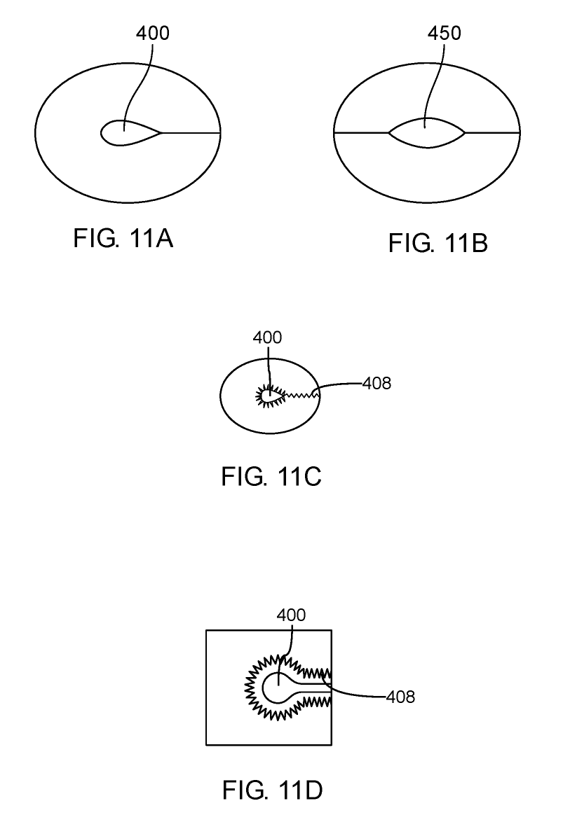

In some embodiments it has been recognized that advantages are realized through providing one or more apertures being located about a tip portion of one or more of the finger portions. In the particular case of those fingers being covered with a capacitive shielding material, these fingers can still be used for providing input to the capacitive resistance touch screen if only a portion of the finger is left uncovered, which portion is strategically placed such that the uncovered portion is only in contact with the screen when desired. For example, a user does not typically touch the screen with the tips of the fingers when writing with a stylus, but at other times, such as when not using a stylus, the tip of the finger can be used to interact with the screen directly. Most users, when intending to interact with the screen, utilize a tip of the interacting finger. However, the finger has a large surface area, particularly when compared to a stylus, and can thus limit accuracy of the touches. It will then be appreciated that an aperture 400 or 450, as shown in FIGS. 11A-D, can be provided which allow for a small contact area between the finger and the screen, when compared to the entire finger. It will then be appreciated that this aperture can be sized according to user preferences in accuracy or user comfort. It will also be appreciated that round, oblong, tear drop, or any number of other shapes can be utilized for these apertures, as contrasted between aperture 400 and 450. It will also be appreciated that a reinforcing stitch or other material 408 can be provided about the edges of such an aperture so as to prevent tearing. The aperture also provides the added benefit of cooling or other ventilation in the finger, as well as prevents the buildup of lint within the finger portions when washing or otherwise laundering the glove as the buildup is provided a means for escape.

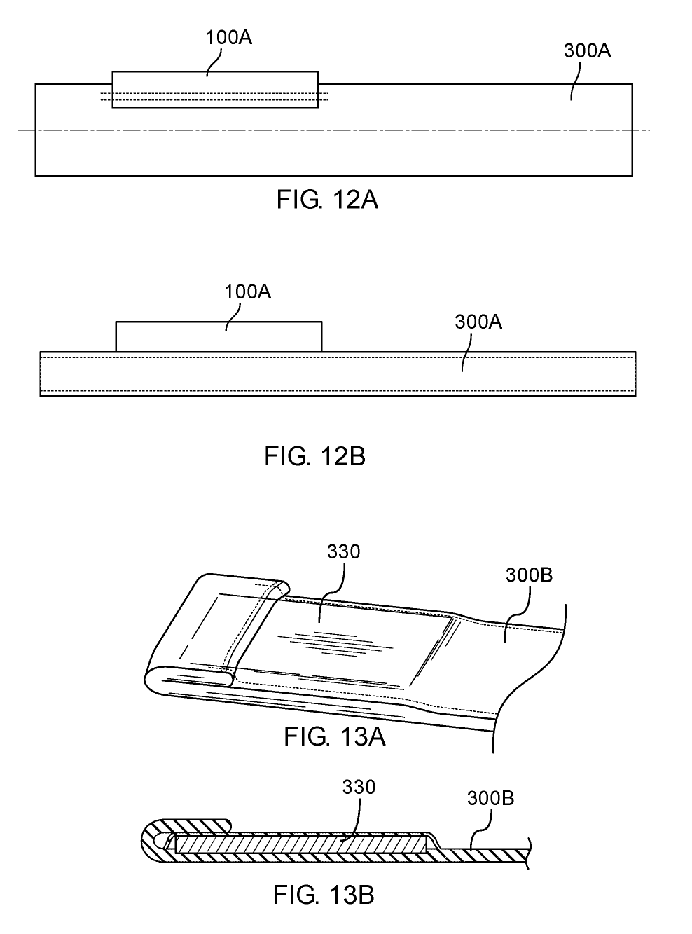

FIGS. 12A-B illustrate how the strap portion can be affixed to the glove by folding the strap material 300A over to sandwich the glove material 100A, i.e. the shielded portion or the shielded and non-shielded portions, between the strap material 300A, then stitching can be provided through the sandwiched glove material and about the edge portion of the glove material so as to provide a clean look to the bottom edge of the strap. In this manner the rolled portion can create an interference interface which resists casual lateral movement during use.

In some embodiments, as shown in FIGS. 1-4, and 13A-B, the strap assembly can be provided with first and second clasp components 330 and 334 respectively configured for closing the strap assembly 300. Specifically, in some embodiments, the first clasp component 330 can be provided with a magnet 334 embedded within yet another alternative embodiment of strap material 300B, wherein the second component 334 can be formed of a magnetically reactive substance so as to provide closure of the strap by means of magnetic attraction. It will also be appreciated the magnet can be provided on the outside of the strap, or in yet additional embodiments, the relative placement can be reversed wherein the second component is a magnet, and a first component has a magnetically reactive substance provided thereon or therein. In yet additional embodiments both the first and second clasp components can be magnets, arranged so as to attract, rather than repel one another.

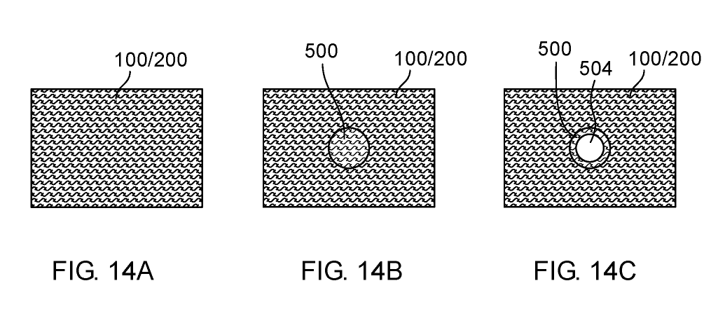

FIGS. 14A-C illustrates an alternative embodiment of an aperture 404 which can be provided in one of the many materials as discussed, either the capacitive shielding or reactive materials of the various embodiments. These apertures 404 can provide ventilation or exposure points for capacitive interaction as discussed above. This method includes providing a bonding agent 500 such as a portion of tacky adhesives such as a rubberized glue or silicone, but can also include super-heated pvc, vinyl other similar fabric printing methods. Then the aperture 504 can then be formed by punching a hole through the bonding agent 500, where the loose threads formed by the punching process will be bound by the bonding agent 500. In most applications, the aperture 504 and bonding agent 500 can have a diameter between 2 mm and 4 mm.

Alternatively, the apertures themselves can also be formed by burning a hole in the fabric such that it melts, similar to fusing the end of a nylon rope, wherein the melting cauterizes the hole, sealing and binding the ends of the fabric threads.

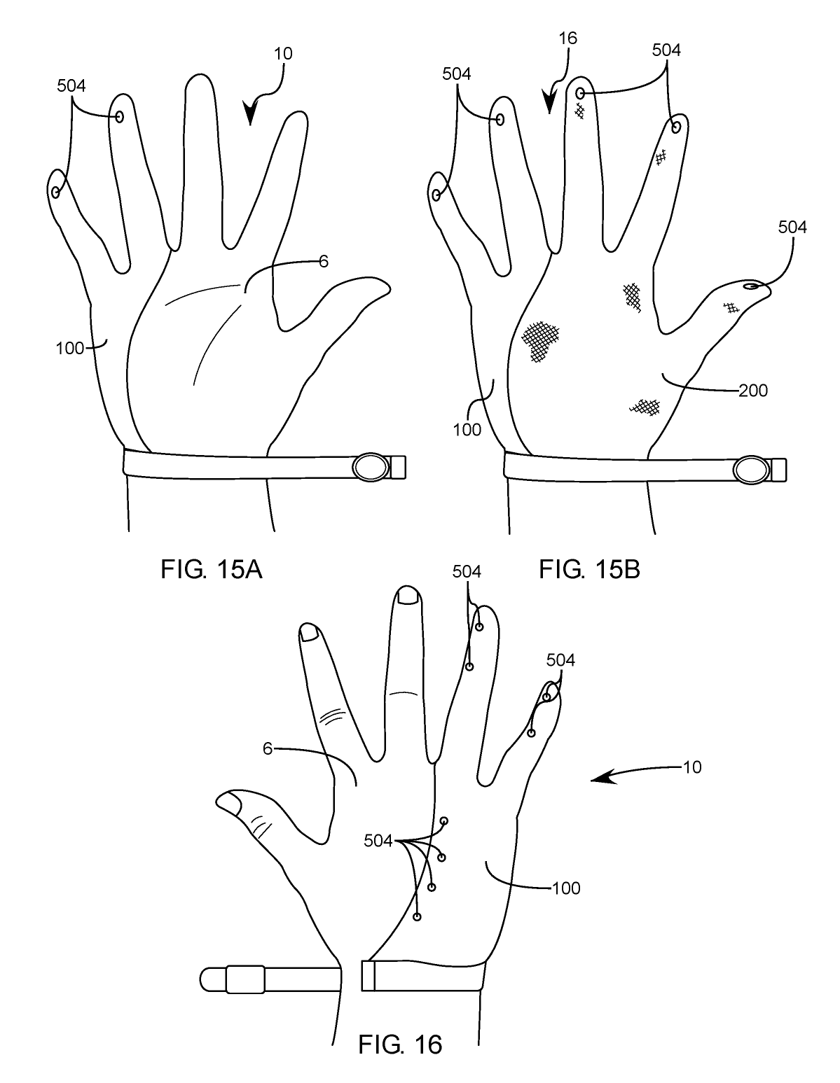

FIGS. 15A-17 illustrates how similar apertures 504 can be provided at different locations on the glove so as to provide either ventilation, such as on the back of the fingers as shown. But can also be provided on the fronts of the fingers to act as apertures which can be utilized for tactile feedback or touch screen interaction. As discussed briefly above, the apertures 504 can have a reinforcement means, such as the bonding agent 500 discussed above or reinforcement stitching so as to prevent tearing thereof. In some embodiments, such as those shown in FIG. 16, the apertures 504 can be provided along a back side of the hand, and be configured to receive items attached thereto, such as charms, etc. for decoration.

In some embodiments, the perimeter or circumference of the hole can be provided with an expandable stitching or a spiral stitch similar to a button hole. These fingertip apertures provide several advantages: first, it allows for better air flow to prevent heat buildup; second, it avoids the usual bunching up of fabric when pieces are all brought together; third, it avoids having the fingertips collect wads of lint and other material; fourth, it allows for exposure for a small portion of the finger for selective interfacing with the touch screen. Additionally, the construction can be done in an aesthetically pleasing way so as to create a distinctive look for example to resemble a tapestry, trademark, or virtually any other desired design. Other examples can include using two different pieces of material in desired colors, instead of one. Additionally, the threading can help define and retain a specific shape of the aperture.

In yet additional embodiments, and as shown in FIG. 18, one or more stylus anchors 600 can be provided on an interior portion of one or more of the finger covers, the stylus anchors 600 being configured to aid with a grasping action of a stylus held by the user's hand.

It will also be appreciated that many styli of the present art are non-powered and rely on a transfer of the capacitance of the user's hand through the stylus to provide the capacitance for reacting to the touch screen. As such, the stylus anchors can be provided as mere grips for powered styli, but can also be provided from a capacitive reactive material so as to transfer capacitance through the glove and into the stylus from either the grips themselves or from the user's hand.

In yet additional embodiments, and as also shown in FIG. 18, the one or more palm anchors 150/550 can be provided with a patterned contact surface area in accordance to the aspects with regard to varying shape or density as discussed with respect to finger anchors above. In some such embodiments, the features of the patterned contact surface area can be arranged having a varying density manner, such as dots arranged in a particular pattern wherein the dots have varying texture and size within the pattern.

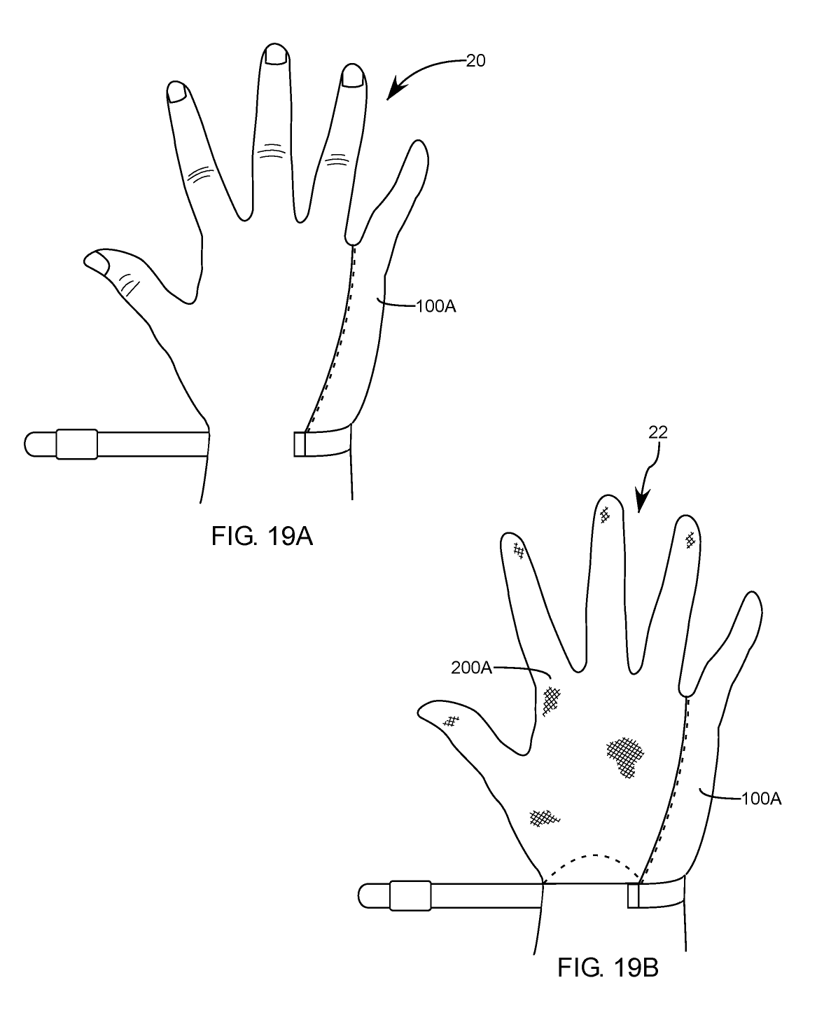

It will be appreciated that in some instances, as illustrated in FIGS. 19A-B, a glove system 20 can be provided which covers only the pinky finger, the material forming the glove system 20 can be provided with as a capacitive shielding material or cover 100A similar to those discussed above. Alternatively, as shown in FIG. 19B, a glove system 22 can be provided which covers the entire hand, wherein a material covering only the pinky finger can be formed of a material having a capacitive shielding properties 100A, with a non-shielding material 200A similar to those discussed above.

The anchors discussed in the various embodiments can be shaped so as to incorporate drag into the touch experience in a controlled way. As discussed above, while the fabric is designed to glide with a smooth, controlled motion, the anchors can be provided so as to modulate this gliding. By providing the radially changing density, the anchors allow the wearer to add drag in a controlled manner. In some cases, drag can be increased until the contact area of the grip is fully engaged, a larger force is transferred through the highest density central portion, and as such a maximum drag is introduced, effectively anchoring part of the body, in this case, fingers three or four, or the palm of the hand in one place against a surface.

It will be appreciated that in many instances there may be no ideal location that satisfies all wearers. Accordingly, while the anchors can be applied to the glove during or after manufacture, the grips can also be provided separately and attached by the individual end user thus allowing placement corresponding to each user's personal preferences. It will also be appreciated that in certain instances a blank glove with no grip portions can be provided wherein the grip material can be applied using a curable serum which can be applied manually by the user in a custom manner.

It will be further appreciated that an interior lining can be provided in certain areas, such as along the palm or edge portion of the hand for comfort or warmth. Meanwhile, other areas, such as the fingertips or between the fingers can be devoid of a lining such that the stretching properties can be preserved, and the glove can maintain a sleek and non-bulky wear-ability.

While several embodiments have been described herein that are exemplary of the present invention, one skilled in the art will recognize additional embodiments within the spirit and scope of the invention. Modification and variation can be made to the disclosed embodiments without departing from the scope of the disclosure. Those skilled in the art will appreciate that the applications of the embodiments disclosed herein are varied. Accordingly, additions and modifications can be made without departing from the principles of the disclosure. In this regard, it is intended that such changes would still fall within the scope of the disclosure. Therefore, this disclosure is not limited to particular embodiments, but is intended to cover modifications within the spirit and scope of the disclosure.

What is claimed is:

1. A touchscreen compatible glove, the glove comprising:
one or more finger covers configured to cover at least an edge portion of a fifth finger of a user's hand, the one or more finger covers being formed of a capacitive shielding material;
a hand cover portion configured to cover an anterior portion of a user's palm adjacent the fifth finger as well as a rear portion located proximal the back of the user's hand;
a closure strap connected to the hand cover portion and configured to attach around a wrist portion of the user's hand;
one or more finger anchors provided about a distal portion of the one or more finger covers; and
one or more palm anchors provided about a screen contacting portion of the hand cover portion.

2. The system of claim 1, wherein the one or more finger anchors have a patterned contact surface area.

3. The system of claim 0, wherein features of the patterned contact surface area decrease in relative density in a radial outward direction.

4. The system of claim 2, wherein features of the patterned contact surface area decrease in relative density in a linear ratio with respect to an associated radius.

5. The system of claim 0, wherein features of the patterned contact surface area are provided with an increased relative density about a first edge, and a decreased relative density about an opposing edge.

6. The system of claim 0, wherein the one or more finger anchors are formed as a multi-pointed star pattern.

7. The system of claim 0, wherein the patterned contact surface area has at least one tapering triangular portion.

8. The system of claim 1, further comprising a dexterous portion configured to cover at least a portion of the thumb and index finger of the user's hand.

9. The system of claim 8, wherein the dexterous portion is formed of a capacitively reactive material.

10. The system of claim 8, wherein the dexterous portion is formed of a capacitive shielding material.

11. The system of claim 8, further comprising one or more apertures formed in a tip portion of one or more of the finger portions.

12. The system of claim 1, further comprising one or more stylus anchors provided on an interior portion of one or more of the finger covers, the stylus anchors being configured to aid with a grasping action of a stylus held by the user's hand.

13. The system of claim 1, wherein the closure strap is configured to close about a back portion of the user's wrist.

14. The system of claim 1, wherein the closure strap is provided with a magnet embedded therein, the magnet being configured to attach to a magnetically reactive substance embedded in the hand portion.

15. The system of claim 1, wherein the hand portion is provided with a magnet embedded therein, the magnet being configured to attach to a magnetically reactive substance embedded in the closure strap.

16. The system of claim 1, wherein the rear portion is provided with one or more attachment apertures along an edge thereof.

17. The system of claim 16, wherein the one or more attachment apertures are provided with a reinforcement means for preventing tearing thereof.

18. The system of claim 1, wherein the one or more palm anchors have a patterned contact surface area.

19. The system of claim 18, wherein the features of the patterned contact surface area are arranged having a varying density.

20. A touchscreen compatible glove, the glove comprising:
one or more finger covers configured to cover at least an edge portion of the fifth finger, the one or more finger covers being formed of a capacitive shielding material;
a hand cover portion configured to cover an anterior portion of a user's palm adjacent the fifth finger as well as a rear portion located proximal the back of the user's hand;
a closure strap connected to the hand cover portion and configured to attach around a wrist portion of the user's hand, wherein the closure strap is configured to close about a back portion of the user's wrist;
one or more finger anchors provided about a distal portion of the one or more finger covers; and
one or more palm anchors provided about a screen contacting portion of the hand cover portion;
wherein the one or more finger anchors have a variable contact surface area;
a dexterous portion configured to cover at least a portion of the thumb and index finger of the user's hand; and
one or more stylus anchors provided on an interior portion of one or more of the finger covers, the stylus anchors being configured to aid with a grasping action of a stylus held by the user's hand.

21. The glove of claim 18, wherein the dexterous portion is provided with an aperture about a tip of a portion covering the index finger.

22. A touchscreen compatible glove, the glove comprising:
one or more finger covers configured to cover at least an edge portion of the fifth finger, the one or more finger covers being formed of a capacitive shielding material;
a hand cover portion configured to cover an anterior portion of a user's palm adjacent the fifth finger as well as a rear portion located proximal the back of the user's hand;
a closure strap connected to the hand cover portion and configured to attach around a wrist portion of the user's hand, wherein the closure strap is configured to close about a back portion of the user's wrist;
one or more finger anchors provided about a distal portion of the one or more finger covers; and
one or more palm anchors provided about a screen contacting portion of the hand cover portion;
wherein the one or more finger anchors have a variable contact surface area; and
one or more stylus anchors provided on an interior portion of one or more of the finger covers, the stylus anchors being configured to aid with a grasping action of a stylus held by the user's hand.
